(19) United States
(12) Patent Application Publication
(10) Pub. No.: US 2007/0074541 A1
(43) Pub. Date: Apr. 5, 2007

(54) Synthesis of germanium sulphide and related compounds

(75) Inventors: John V. Badding, University Park, PA (US); Daniel William Hewak, Hampshire (GB); Chung-Che Huang, Hampshire (GB)

Correspondence Address: Reidlaw, 1926 South Valleyview Lane, Spokane, WA, 99212-0157, US

(73) Assignee: University of Southampton, Southampton, Hampshire (GB)

(21) Appl. No.: 10/575,199

(22) PCT Filed: Oct. 8, 2004
(86) PCT No.: PCT/GB04/04293

§ 371 Date: Jun. 2, 2006

(30) Foreign Application Priority Data
Oct. 10, 2003 (GB) 0323805.2

(51) Int. Cl. C03B 37/023; C03B 37/018

(52) U.S. Cl. 65/413; 65/385

(57) ABSTRACT

The invention relates to synthesis of germanium sulphide glasses and optical devices formed therefrom. In a chemical vapour deposition process, germanium tetrachloride is reacted with hydrogen sulphide at temperatures in the range 450-700° C. to form germanium sulphide. Lower temperatures within this range of 450-550° C. directly produce a glass, whereas higher temperatures within the range of 600-700° C. produce a crystalline powder which can then be reduced to a glass by subsequent melting and annealing. The reaction is preferably carried out at atmospheric pressure or slightly higher. Thin films and bulk glasses suitable for optical waveguides can be formed directly in one processing step as can powders and microspheres. The materials synthesised are of a high purity with low oxide impurities and only trace levels of transition metal ions.

### BACKGROUND OF THE INVENTION

The invention relates to processes for the synthesis of chalcogenide glass based on germanium sulphide, in particular optical glass for optoelectronic applications. More especially the invention relates to improved methods for the synthesis of the glass and related compounds, apparatus for the same, and to thin films, bulk glass, microspheres and to waveguides, optical fibre preforms, optical fibre and optical devices using such materials.

The production of high purity chalcogenide glasses is essential for a wide range of applications that exploit the material in bulk, thin film, thick film, microsphere and optical fibre form. Applications include infrared transmitting glass and optical fibre, optical data storage using phase change or holographic data storage, infrared windows and lenses for used in, for example, thermal imaging and infrared laser systems, medical applications including endoscopy, telecommunications devices exploiting the low phonon energy and resulting-unique spectroscopic properties or, for other applications such as high speed switching exploiting the materials high optical nonlinearity, to name only a few examples [1].

Throughout this application, where publications are referenced, the disclosures of these publications in their entireties are hereby incorporated by reference into this invention in order to more fully describe the state of the art and the applications to which this invention pertains.

A chalcogenide is a materials based on one or more of the chalcogens, sulphur, selenium or tellurium. It can form a crystalline solid, ceramic or amorphous glass.

As a glass, it has the properties of an amorphous semiconductor with an absorption edge typically in the visible or near infrared corresponding to a bandgap energies of ˜3 eV. A chalcogenide glass can be regarded as a “soft semiconductor”, soft because its interatomic bonding is weak and a semiconductor because it possesses a bandgap energy, which is characteristic of semiconductors. For other semiconductor properties, for example, electron mobility, a chalcogenide glass appears to possess intermediate properties between a crystalline material (eg. Si) and a polymer (eg. Poly-N-vinylcarbazole).

As an optical material, chalcogenides offer a wide range of properties that have been exploited or have the potential for new, relatively unexplored applications.

The conventional method of fabricating a chalcogenide glass is sealed ampoule melting. In this process the elements, as chunks or powders, are placed in a quartz tube, which is then evacuated to low pressures, typically 10 −3 Torr or lower, and then sealed by melting and fusing the open end. The tube is placed in a furnace that typically rocks or oscillates the sealed ampoule in order to homogenise the melt. The ampoule is then cooled, broken open and the glass is then further processed to form, for example, thin films, optical fibre and optoelectronic devices. Thin films of chalcogenide glass can be deposited by a number of methods including evaporation, sputtering, ablation and sol gel processing. These techniques can be useful but in general suffer from problems associated with impurities or difficulty in achieving the desired stoichiometry.

Sealed ampoule melting has a number of disadvantages, in particular the difficulty in obtaining high purity starting materials limits the purity of the resulting glass. The sealed ampoule is a closed system and any impurities within the starting materials are trapped in the sealed system and incorporated into the glass. In particular oxygen impurities, carbon and hydrogen resulting from the use of organic compounds, and transition metal ions, all introduce undesirable absorption bands in the transmission spectrum of the glass [2].

Other disadvantages include the difficulty in scaling up the process to large and more economical melt sizes. Moreover, sealed ampoules when heated can build up dangerously high pressures.

Chemical vapour deposition (CVD) is another process that has been extensively used for the production of powders and coatings and its applications are widespread. In many cases the thin films produced by CVD are only nanometers in thickness, for example, when the process is used to form coatings. In other applications, layers are built up, layer by layer, to several millimeters in thickness. These layers can be porous and described as a soot, or under the proper conditions can be hard and either crystalline or amorphous. The reaction of the precursors in a gas stream at temperature can form powders, which are commercially useful. At higher temperatures, the powder, carried by the gaseous stream within the reaction chamber can melt and if cooled sufficiently quickly can form micro- or nano-sized spheres that are amorphous. If the powder is allowed to collect and then heated to its melting point, a bulk material can accumulated which upon cooling forms a bulk glass or crystal. It is desirable to form these powders, thin films, microspheres or bulk materials with very high purity, but at low production costs and with a simple process. In addition, being able to form the desired materials at atmospheric pressures tremendously simplifies the process and the costs, resulting in a more economical and viable fabrication process for government and commercial users. In addition to reactions that take place in a heated furnace, CVD is readily adapted to a combustion process in which a combustion flame provides the necessary high temperature environment for the deposition of the reactants from the solid, liquid and/or gas precursors. The key advantage of this method of chemical vapour deposition is the ability to deposit films without the need for a furnace or reaction chamber. Indeed, the synthesis of silica, by the reaction of oxygen and silicon tetrachloride in a oxy-hydrogen flame, is a well know CVD process used to fabricate silica glass in a high purity form which used in thin film form for a variety of optoelectronic application. Alternatively, bulk material can be built up, layer by layer to form a solid rod which is subsequently drawn into optical fibres. This procedure revolutionised optical fibre technology, allowing the realisation of practical low loss optical fibres.

It has long been recognised that it would be highly desirable if a CVD process could be found that is suitable for producing high purity chalcogenide materials and there has been considerable work devoted to this objective, as now described.

1984 Work by Melling [13] identified chemical vapour deposition (CVD) as an attractive process if a suitable reaction can be found. The reaction of, for example, germanium chloride (GeCl₄) and hydrogen sulphide (H₂S) was deemed unsatisfactory because of a low reaction rate and a low yield of deposited product. They concluded that no workable process had been reported.

1985 Okada et al, [4] described a method of fabricating chalcogenide glass fibres using oxygen free compounds containing a chalcogenide element, together with H2S which were thermally decomposed to form a chalcogenide glass film. In a similar process, Okada et al, [5] described a method for the production of chalcogenide glass fine powder. In both cases they utilised organic metal compounds containing a chalcogenide element [eg. Ge(SC₂H₅)₄] which is unsatisfactory for the production of high purity chalcogenide materials. Organic materials, containing carbon and hydrogen, result in undesirable CH, SH and other related impurities in the resulting materials [2].

1985 Katsuyama et all [6] describe the formation of Ge—Se based glass, a glass system which does not provide the transmission in the visible and near IR wavelength regions achieved by Ge—S glasses. They required temperatures of 800° C. for the deposition of Ge—Se and a second processing step to achieve bulk glass. This second step required evacuation to a vacuum of about 10⁻³ torr. Moreover to eliminate oxide impurities, processing under NH₃ and CO gas flow was required.

1992 Macinnes et al [7] described the chemical vapour deposition of cubic gallium sulphide thin films using a single molecule precursor [(t-Bu)GaS]₄ to produce crystalline films. Glass films however were not achieved with this process and the crystalline products that resulted are unsuitable for photonic applications. Moreover, the organic precursor described would result in unacceptable carbon and hydrogen impurities. Similarly 1996 Schultz [8] describe a cubane precursor with similar disadvantages.

1994 Fujiura et al, [9] describe a process to obtain a glass having a low transmission loss by mixing a glass forming gas with a alpha-diketone complex of a rare earth element and reacting in a vapour phase or on a substrate. AsCl₃ or GeCl₃ (in a bubbler), H₂S and a beta-diketone complex of Pr are supplied through a mass flow controller to a reaction chamber at a temperature of 200-300° C. under a pressure of 100 torr (0.13 Atm), where this pressure is maintained by a vacuum pump connected to the system. Although no data is provided in this paper on transition metal impurities, it is assumed that these would have been very high due to the use of stainless steel bubblers for the liquid precursors. In addition the use of ketones, which are organic compounds would have introduced impurities to the process.

1999 Tawarayama et al [10] developed a process for preparing Ga-based sulphide glass that was substantially free from SiO₂. A process wherein the Si content of a starting material is selected so that the content of any foreign material composed mainly of SiO₂ in the Ga-based sulphide glass does not exceed 200 ppm produces the glass. This process is again unsatisfactory because it relies upon pre-selection of suitable starting materials rather than providing a process that inherently deposits a high purity product.

2000 Rostislave et al [11] describe a related processing method, plasma enhanced chemical vapour deposition (PECVD) which is used to prepare a silica fibre in which the core is doped with a fraction of a chalcogenide element to significantly increase the refractive index. The resulting compound however contains silica and would be unsuitable for infrared transmission. Pure chalcogenides based on sulphur offer transmission to beyond 7 microns whereas glasses containing silicon and oxygen do not transmit well beyond 2 microns.

Atmospheric pressure chemical vapour deposition (APCVD) has recently been reviewed in detail by Sheel and Pemble [12]. They discuss the advantages of the process and provide an extensive list of references. No discussion is provided on the CVD of chalcogenide materials and the authors acknowledge that a “limited material range [is] depositable” and “many materials could be deposited by CVD than currently are”. They therefore suggest the advantages of the process only in general term without realisation its applicability to chalcogenide or sulphide materials.

The precursors that have been proposed for the deposition of germanium sulphide have proven unsatisfactory. To date no commercially viable synthesis method exists and commercial germanium sulphides are synthesised by melting from the solid-state germanium metal and sulphur. This procedure is problematic. It is difficult to purify elemental germanium, which readily oxidised in the presence of air. The use of chemical vapour deposition to synthesise germanium sulphide based compounds has also been problematic. The precursors used for the deposition of germanium sulphide include, for example, germanium (IV) ethoxide, germanium diethylamide, germanium (IV) ethylmethylamide, germanium isopropoxide, germanium (IV) methoxide and a range of organic precursors are shown by the references herein to be problematic and unsatisfactory. Current methods are not suitable for the high purity glass required for optoelectronic applications and no practical synthesis method has yet to be developed.

Despite these advances to the field, there is still a need for an improved method for the production of these glasses. There is no simple, one step method of producing chalcogenide materials of a high optical quality. By providing a practical, inexpensive method of depositing chalcogenides, in particular sulphides, users of chalcogenide materials could benefit from the advantages of high purity vapour deposited materials. Moreover, the work in the field of optoelectronics, which has successfully spawned a wide range of important devices, based on planar, microsphere and fibre forms of glass could benefit from the advantages which chalcogenide offer over silica based glasses.

### SUMMARY OF THE INVENTION

The invention provides a method for fabricating germanium sulphide glass by reacting gaseous flows of germanium chloride and hydrogen sulphide in a reaction chamber at a suitable reaction temperature for inducing the reaction:
GeCl₄+2H₂S [symbol] GeS₂+4HCl

This simple reaction is preferably carried out at near atmospheric pressure and has been used to fabricate high purity germanium sulphide glass films.

The invention further relates to the apparatus and procedure for producing practical germanium sulphide and germanium sulphide based glass, powder, thin films, microspheres, waveguides, optical fibre preforms and the devices realised from the same.

Through changes in the temperature and pressure at which the reaction occurs and utilising apparatus, designed and constructed within our laboratories we have successful deposited high purity germanium sulphide glass and related compounds and with high efficiency collected crystalline germanium sulphide which we have melted in situ to form bulk glass. All processes take place in a single experimental stage.

Germanium sulphide chalcogenide glass is a promising material for a wide range of photonic applications. Its properties include a low-phonon energy, low-toxicity, high glass transition temperature, and superb photo-modification characteristics. The glass has the ability to incorporate rare earth ions, transition metals and other dopants. These properties, together with high non-linearity and well-documented spectroscopic properties, make it an excellent candidate for devices based on planar channel waveguide structures or optical fibre geometries.

As an optical fibre, germanium sulphide based waveguides provide infrared transmission particularly in the 3-5 micron region where traditional silica, oxide and halide fibres do not transmit. These fibres can be doped with for example rare earth ions to form amplifiers and lasers. The nonlinearity of the fibres allows optical switches to be fabricated, while the photosensitivity allows the incorporation of fibre Bragg gratings. These fibres find application in telecommunications, remote sensing, aerospace and defence applications, medicine, laser power delivery, to name a few examples.

In thin film form, germanium sulphide based waveguides allow optical integrated circuits to be fabricated in a multifunctional material with active and modifiable properties. Channels which guide light, split light into several waveguides, or switch light from one channel to another, by optical or thermal mechanisms, can be realised. As a thin film, its reflectance or resisitivity can be modified by both optical and thermal mechanisms. This property finds application in the field of optical data storage using phase change media.

Germanium sulphide glass provides not only a important and viable optoelectronic material on its own but through modification of this basic composition through the addition of additional elements, its range of application can be expanded. For example, it is well known that the addition of phosphorous, gallium or arsenic enhances the ability of the glass to be drawn into optical fibre [2]. These glass modifiers are also compatible with the chemical vapour deposition process.

The chemical vapour deposition process allows the direct synthesis, as we have shown, of not only thin films of glass, but bulk glass, powder and microspheres. The bulk glass can be formed into optical fibre preforms that are then drawn into optical fibre form. All these forms of germanium sulphide benefit from the advantages of the process we have developed.

The invention provides in one aspect a method of synthesising germanium sulphide using chemical vapour deposition, comprising:
(i) providing a gas mixture containing germanium tetrachloride (GeCl₄) and hydrogen sulphide (H₂S); and
(ii) passing the gas mixture into a reaction chamber that is operated to provide a reaction temperature of between 450-700° C. for the reaction:
   GeCl₄+2H₂S [symbol] GeS₂+4HCl
thereby synthesising germanium sulphide in solid form and hydrogen chloride in gaseous form as a byproduct.

The germanium sulphide can be deposited in glass form, for example as a glass film. The glass film may be deposited on a planar substrate or on the inside of a hollow tube that is arranged in, or forms part of, the reaction chamber, as would be done as the first stage of forming an optical fibre preform. The composition of the glass film can be varied during its deposition to provide a desired refractive index profile. The variation may be stepwise or continuous to provide whatever waveguiding or other profile is desired.

It is advantageous when carrying out the process that the reaction chamber is maintained at a pressure close to atmospheric during the reaction. Close to atmospheric can be considered to be normally within 10% of atmospheric pressure, but could be between 1/2 and 3/2 atmospheres. Preferably, the pressure in the reaction chamber is maintained slightly above atmospheric pressure so that any leakage that may occur takes place outwards, thereby avoiding impurities being introduced into the reaction chamber.

In one group of embodiments, the reaction chamber is operated to provide a reaction temperature between the temperature of glass transition and the temperature of onset of crystallisation of germanium sulphide, typically 500° C.+/−50° C., to induce formation of the germanium sulphide in glass form through the reaction. This can be achieved by a variety of means, for example by direct heating of the whole chamber, e.g. resistively or radiatively, by heating only the substrate, or by a combustion reaction inside the reaction chamber.

In another group of embodiments, the reaction chamber is operated to provide a reaction temperature between the temperature of onset of crystallisation of germanium sulphide and its melting temperature, typically 650° C.+/−50° C., to induce formation of the germanium sulphide in crystalline form through the reaction. The crystalline material can then be melted and resolidified to form a glass by: (a) sealing the reaction chamber containing the germanium sulphide in crystalline form; and (b) heating the sealed reaction chamber to melt the crystalline form of the germanium sulphide and resolidify it into glass. To form crystalline material in large volumes, the reaction chamber is a vertical tube furnace.

Another form of material that can be produced is spheres or microspheres. This can be done by directing the gas mixture through a nozzle to create a reactable spray in the reaction chamber, thereby to form molten droplets which then freeze to form spheres or microspheres of germanium sulphide.

The gas mixture can be formed by: providing a first gas stream of a carrier gas, such as an inert gas, containing the germanium tetrachloride (GeCl₄); providing a second gas stream of the hydrogen sulphide (H₂S); and mixing the first and second gas streams prior to introduction into the reaction chamber. Alternatively, the hydrogen sulphide (H₂S) can act as the carrier gas for the germanium tetrachloride (GeCl₄).

Various additional components can be included in the growth process. Modifiers such as P, Ga, As may be included. Metal chlorides may be added to the gas mixture in order to modify the germanium sulphide being synthesised. Lanthanide and/or transition metal elements may be incorporated. Moreover, oxides of the following elements can be included to increase the photosensitivity of the compound: Sn, B, Na, Li, K, Ag, Au, Pt in order to allow fabrication of gratings, directly written waveguides or other structures.

The method of the invention allows very high purity material to be produced. Specifically, it is possible to produce a compound of germanium sulphide in which transition metal impurities are present at levels of less than 1 ppm, transition metal impurities are present at levels of less than 0.1 ppm, carbon impurities are present at levels of less than 1 ppm, and oxygen impurities are present at levels of less than 1000 ppm. Clearly, the reference to impurities refers to unintentional dopants and excludes intentional transition metal or other dopants that may be used for device applications.

It will be understood that using the method glass in a variety of forms may be provided. For example, bulk glass rods or elements can be made as well as planar or optical fibre waveguide structures. The glass may also be microstructured, e.g. to form a holey optical fibre. The waveguides may be suitably dimensioned to be monomode or multimode.

Optical devices made from the glass may be active, i.e. gain inducing, or passive.

Germanium sulphide fibre may be used in non-linear devices and fibre amplifiers for telecommunications, for example. Devices based on third order optical non-linear processes can be made. Germanium sulphide glasses show large intensity dependence on refractive index without appreciable linear absorption at the optical communications wavelength. This is required for all-optical switching. Germanium sulphide planar waveguides may be used for analogous devices.

### BRIEF DESCRIPTION OF THE DRAWINGS

For a better understanding of the invention and to show how the same way may be carried into effect reference is now made by way of example to the accompanying drawings.

FIG. 1 shows a scanning electron microscope (SEM) images of the cleaved edge of a germanium sulphide thin glass film on a calcium fluoride substrate.

FIG. 2 shows the apparatus and one embodiment of the process here used for deposition germanium sulphide glass thin films.

FIG. 3 shows the typical Raman spectrum of germanium sulphide glass thin film by chemical vapour deposition (CVD).

FIG. 4 shows the typical X-ray diffraction (XRD) pattern of germanium sulphide glass thin film by chemical vapour deposition (CVD).

FIG. 5 shows the Alpha-step profile of ribs structures of germanium sulphide glass waveguide by photolithography and Ar ion-beam milling

FIG. 6 shows the SEM picture of ribs structures of germanium sulphide glass waveguide by photolithography and Ar ion-beam milling

FIG. 7 illustrates the guiding of light by the rib structures formed from germanium sulphide glass thin films by photolithography and etching and the experimental analysis used to assess the optical waveguide transmission loss.

FIG. 8 shows the apparatus used to fabricated a bulk glass sample

FIG. 9 shows the typical UV-VIS spectrum of germanium sulphide glass by CVD.

FIG. 10A shows the infrared transmission spectrum for one sample.

FIG. 10B shows the visible to infrared transmission spectrum for another sample.

FIG. 10C shows the transmittance for a sample.

FIG. 11 shows the thermal properties of germanium sulphide glass by DTA analysis.

FIG. 12 demonstrates conformal coatings on a structured substrate.

FIG. 13 demonstrates deposition on a variety of substrate materials.

FIG. 14 shows direct heating of a substrate in a cold wall reactor.

FIG. 15 shows a germanium sulphide fibre used for delivering an infrared laser output beam;

FIG. 16 shows a fused-taper 50:50 coupler made of germanium sulphide fibre;

FIG. 17 shows a germanium sulphide fibre bundle used for array detector imaging;

FIG. 18 shows a 1300 nm fibre amplifier based on a Pr:doped germanium sulphide fibre;

FIG. 19 shows an Er:doped germanium sulphide fibre laser;

FIG. 20 shows a high power Nd:doped germanium sulphide fibre laser;

FIG. 21 is a cross-section through the optical fibre of FIG. 20;

FIG. 22 shows a spectral broadening device based on a germanium sulphide holey fibre;

FIG. 23 is an optical fibre gas sensor;

FIG. 24 is an optical switch based on a germanium sulphide fibre grating;

FIG. 25 is a further optical switch based on a null coupler made of germanium sulphide fibre;

FIG. 26 shows an in-line dispersion compensator formed of a section of germanium sulphide optical fibre with high negative dispersion; and

FIG. 27 shows a large core germanium sulphide fibre used for power delivery of a high power infrared laser.

### DETAILED DESCRIPTION

While silica glass is an ideal optical material, particularly in the form of waveguides for telecommunications, numerous optoelectonic and photonic devices require materials that transmit at wavelengths for which silica glass does not transmit or which offer active properties such as nonlinearity or the ability to host large concentrations of dopants such as the rare earth ions. Medical applications require fibres which transmit radiation at wavelengths near 3 microns, a wavelength which is readily absorbed by human tissue. Aerospace applications require fibre which matches the atmospheric transmission windows in the 3-5 micron region and optical fibre sensing applications would benefit from fibre which transmits near the absorptions of common or dangerous gases, for example, carbon monoxide, whose fundamental absorption lies near 5 microns. Silica based fibre does not transmit beyond 2 microns; these longer wavelengths require a glass whose transmission extends further into the infrared.

The need for infrared-transmitting fibres was recognised over 40 years ago and work began in earnest to develop new glasses, glasses based on heavy metals and sulphides, whose properties allow transmission beyond 2 microns. Today, these glasses exist, and fibres have been drawn, extending the transmission of optical fibre to beyond 10 microns. These glasses however are difficult and time consuming to prepare and fibre drawing is problematic.

The key to silica fibre success and the low transmission loss that these fibres offer lies in a simple chemical reaction that allows the synthesis of high purity silica. Silicon tetrachloride is reacted with oxygen to form high purity silica:
SiCl₄+O₂=SiO₂+2Cl₂ (2)
in a chemical vapour deposition process which ensures high purity glass directly forms into the rods that are drawn into fibre.

Sulphide glasses on the other hand are prepared by more traditional and ancient glass melting techniques; raw materials are purified, mixed and then melted in crucible. The resulting glass is then purified and reformed into rods that are then drawn into fibre. This indirect route is expensive, less efficient than chemical vapour deposition and time consuming. The resulting fibre, even today, has a transmission loss typically one thousand times poorer than silica.

The invention relates to optical glass, in particular chalcogenide based optical glass for fabricating a wide range of optoelectronic devices. More particularly, the invention relates to germanium sulphide glass and related compounds, and to optical devices using such glass synthesised directly by chemical vapour deposition (CVD). This direct synthesis can be used to produce glass or crystalline forms of the material. The material can be deposited in a variety of ways, for example as thin films, microspheres, powder, or inside tubes suitable for collapse into optical fibre preforms similar to standard silica fibre preform creation.

The process of the invention is based on the reaction of germanium chloride with hydrogen sulphide. The process conditions must be chosen to ensure that sufficient reaction products are obtained. Study of the thermodynamics of the reaction:
GeCl₄+2H₂S=GeS₂+4HCl (3)
reveals the efficiency of our procedure. A thermodynamic study of the reactants and products of the reactions therefore follows. In any reaction, the difference between the Gibb's free energy of the reactants and products allows the calculation of the equilibrium constant (K) of the reaction where
ΔG_{reaction}=ΣΔG_{products}−ΣΔG_{reactants} (4)

Here ΔG=−RT ln(K) where R is the universal gas constant and T is the temperature in Kelvin.

The data shown in table 1 demonstrated the efficiency of the reaction we describe. The raw data is well known and tabulated in for example Thermochemical Data of Pure Substances, John Wiley & Sons; 3rd edition (Dec. 5, 1997).

TABLE 1
Feasibility of the reaction of hydrogen sulphide (H₂S) and germanium
tetrachloride (GeCl₄) to form germanium sulphide (GeS₂)

| | Room | | |
|---|---|---|---|
| | Temperature | 500 K | 800 K |
| ΔG (kJ/mol) HCL | −95.3 | −97.2 | −99.4 |
| ΔG (kJ/mol) GeS₂ | −154.6 | −151.2 | −141.4 |
| ΔG (kJ/mol) H₂S | −33.3 | −40.2 | −45.7 |
| ΔG (kJ/mol)GeCl₄ | −461.5 | −436.0 | −398.5 |
| Σ ΔG (kJ/mol) | −7.6 | −23.5 | −49.3 |
| K | 21.1 | 281.7 | 1616.0 |

The large and positive value of the equilibrium constant K at temperatures of 500 K and higher indicate a very favourable reaction in which the synthesis of germanium sulphide is preferred.

The present invention provides a series of related methods by which the chemical vapour deposition method can be used to directly, simply and inexpensively fabricate chalcogenides based on germanium sulphide in the form of powder, microspheres, bulk glass, waveguides and optical fibre preforms.

The embodiment of this method comprises in its most basic form, precursors consisting of gaseous hydrogen sulphide and a suitable carrier gas to deliver a vapour of germanium tetrachloride, at atmospheric pressure, to a reaction chamber at a carefully selected temperature. In this embodiment, the hydrogen sulphide can serve both as a reaction precursor and a carrier gas for the germanium tetrachloride. Alternatively, an inert gas such as argon or nitrogen, can serve as the carrier gas. The carrier gas is bubbled through the liquid germanium tetrachloride at a rate, which delivers a desired quantity of the precursor to the reaction chamber. Similarly, the flow of the hydrogen sulphide is controlled, through the use of flow meters or mass flow controllers, to deliver sufficient precursor to react fully with all the delivered germanium tetrachloride. Within the reaction chamber the pressure can be ambient, or it can be slightly above ambient pressure to ensure the exclusion of outside contaminants. The pressure of the precursors being delivered, and thus the flow rate of precursors to the reaction area is chosen to match the desired deposition rates. One of skill in the art would recognise that there are a variety of means for suitable delivering the precursors to the reaction area. This could simply be through flow from a pressurised source, for example, a compress liquid source of the gases. Alternatively, the gases can be delivered under pressure, including but not limited to the use of compressors. This would increase the deposition rate and the efficiency of the reaction through the increased mass flow, however reaction would remain at ambient or slightly above ambient pressure. The outlet ports that deliver the gaseous and vapour precursors to the heated reaction area would have a shape, similar to a nozzle, which would ensure mixing of the precursors prior to the desired reaction taking place. Within the reaction area, the temperature would be raised and regulated. This would provide the energy source to drive the reaction to the desired products, in this case germanium sulphide, along with the by-product of the reaction, hydrogen chloride. The desired material would be deposited into the reaction area as a solid whereas the undesired by-product, would by virtue of the ambient or near ambient pressure, be exhausted through an appropriate extract. At a reaction temperature between the glass transition temperature and the onset of crystallisation of germanium sulphide, the product of the reaction would be deposited as an amorphous solid. At higher temperatures, typically 600° C., a crystalline power form of germanium sulphide would be deposited. With a suitably designed reaction area, the desired chalcogenide material, in this case, germanium sulphide, can be collected for use after deposition is complete.

In a further embodiment of this method, a suitable planar substrate is located within the reaction area. The surface of the substrate serves as a collection area in order to obtain a thin or thick film of the chalcogenide product. One of skill would recognise that the thermal properties of the substrate should be compatible with the deposition temperature. Furthermore, if a homogeneous and amorphous thin film is desired, the thermal expansion of the substrate must match that of the chalcogenide film being deposited.

In a further embodiment of this method, only the substrate itself is heated to the reaction temperature. This increases the efficiency of the reaction, limiting the reaction to the surface of the substrate. One of ordinary skill would recognise that there are a variety of methods for locally heating the substrate including a simple localised heating element or RF induction heating.

In a further embodiment, the nozzles through which the precursors are delivered to the reaction area are chosen to have an internal diameter of 10 nm to 500 microns, more preferably 100 to 1000 nm. The precursors then form a nebulised solution spray and, thereafter, this reactable spray is exposed to the energy source to react and form molten droplets, which through natural surface tension form spherical droplets, which on exiting the reaction area cool and form spheres or microspheres of a scale 1 nm to 1 mm in diameter. These may be crystalline or glass depending on the parameters.

In a further embodiment of this method, the reaction chamber consists of two or more zones, which are held at different temperatures to favour both the reaction efficiency and the collection of the reaction products. One zone is favourable for the reaction efficiency, while the additional downstream zones can be at a higher temperature to melt products of the reaction to a liquid form to allow them to collect in a suitable vessel. Alternatively, downstream zones can be of much lower temperature to prevent the loss of unreacted precursors through the exhaust.

In an alternative embodiment of the method, one or more of the carrier gases is combustible and its burning in the reaction chamber provides the energy source and thus reaction temperature to induce the reaction. This carrier is selected such that its combustion does not introduce impurities to the process. In a further embodiment, the energy source consists of a plasma source.

In an alternative embodiment of the method, one or more of the carrier gases or precursors is delivered to the reaction area at pressures in excess of that which would normally be delivered from a compressed gas source. In particular the pressure and temperature of the precursors would be at or near their critical point, at which the distinction between gas and liquid no longer applies. This would maximise the delivery rate of the precursors to the reaction area.

In an alternative embodiment of the method, deposition occurs on the inside wall of a cylindrical hollow substrate, more easily envisioned as a tube. The energy source is applied from the outside, heating the substrate tube to the reaction temperature. In a further embodiment, the tube is rotated to ensure even deposition over the entire surface area of the tube. In a further embodiment, deposition continues such that several, up to several thousand or more layers are deposited, building up to a thick walled tube. In a further embodiment, the temperature of the substrate tube is increased to sinter and solidify the deposited material into a solid rod. In a further embodiment, the composition of the precursors is changes during the deposition process to vary the radial composition of the resulting solid rod. One of skill would recognise that there are many alternative methods for altering the geometry of the deposition process to be able to form a solid rod. A solid or hollow rod may then be collapsed into an optical fibre preform, for example.

In a further embodiment, the substrate is a solid rod on which layers are deposited.

In another embodiment, the apparatus, reaction chamber and/or substrate are fabricated from glass. One of skill would recognise that pure silica or borosilicate glasses provide suitable, and impurity free materials for this process.

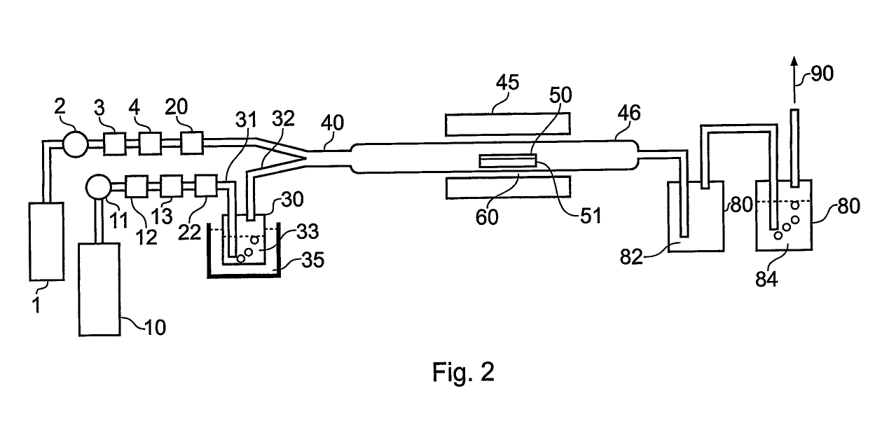

In addition to the above methods, the present invention also provides an apparatus for the practical application of the CVD process for germanium sulphide deposition. Referring now to FIG. 2, an apparatus for the deposition of films and powders using germanium chloride precursors is shown. The apparatus consists of a compressed gas source of hydrogen sulphide (1) whose delivery pressure is monitored by a regulator (2). The gas is filtered to further remove any impurity moisture using a commercial SAEA filter (3) and passes through a particle filter (4) of pore size (3 nm) before entering a mass flow controller (20) and delivered through to a silica glass mixing region (20). The gas supply tube (4) consists of inner PTFE tubing surrounded by stainless steel outer tubing. Dry nitrogen is purged between the inner and outer tube to further prevent the indiffusion of moisture. This double clad tubing is important since it ensures that only the highest purity precursors reach the energy source (45). A second gas supply, consisting of a liquid source of argon (10) delivers an inert carrier gas via a pressure regulator (11) to a commercial argon gas dryer BOC (12) and a particle filter (13) of pore size (10 nm). This gas flow is also delivered through PTFE tubing skirted with dry nitrogen and is also monitored by a mass flow controller (22). The argon carrier gas is delivered to a bubbler system which consists of a borosilicate glass vessel (30) with an input (31) and output (32) port arranged such that the input port allows the gas flow to escape into a liquid precursor (33) which in the case of this example is germanium tetrachloride (GeCl₄). This bubbler unit is immersed in a dense liquid, for example, silicon oil (35) which serves as an insulating layer to maintain a constant temperature for the liquid precursor. Upon flowing out through the exit port (32) the argon carrier gas now hosts a vapour of GeCl₄, which is delivered to the mixing region (40). A silica reaction chamber (45) contains one or more substrates (51) in this case a polished slab of calcium fluoride. The reaction chamber is heated to a temperature of 500° C.+/−50° C. and the flow of carrier gas, hydrogen sulphide and germanium tetrachloride is maintained for 30 minutes. The reaction products consist of germanium sulphide which is deposited as a thin amorphous film (50) onto the substrate (51) and hydrogen chloride gas that is removed from the reaction chamber (45) through the exit port (46). The exhaust is bubbled through a solution of dense liquid, in this case silicon oil, which raises the internal pressure to the system slightly above ambient pressure, i.e. provides slight overpressure. This ensures that any unavoidable leakage in the system, however so small, is to the outside environment and not inwards to the reaction chamber. This maintains the integrity and purity of the process. To further ensure the integrity of the process, the exhaust gas passes through a second dry bubbler (85). This is here to prevent backpressure during the cooling down of the furnace resulting in transfer of the bubbling liquid (85) into the reaction chamber. After the deposition process is complete and the reaction chamber cooled, the substrate can be removed from the furnace for its desired application.

One of ordinary skill in the art would recognise that other substrates can be coated by the method and apparatus of the present process and that variations of the apparatus to optimise, for example, flow rates, mixing region, heat source are possible. In addition, the energy source which provides the temperature required for an efficient reaction could be delivered in a variety of methods which include resistive heating, RF induction heating, heating by flame, infrared lamp and other such energy sources. Furthermore, additional reactive or passive components or glass modifiers can also be introduced to the reaction chamber to modify or optimise the deposited thin film for other desired applications. With this in mind, the key feature of the apparatus and process are the ability to achieve germanium sulphide thin films at atmospheric pressure in a simple and efficient process.

The exploitation and application of this invention is best described through a series of examples, which describe the highly desirable attributes of the invention. Other features of the invention will become apparent from the following examples, which are for illustrative purposes only and are not intended as a limitation upon the present invention.

### EXAMPLE 1

### Thin Film Deposition

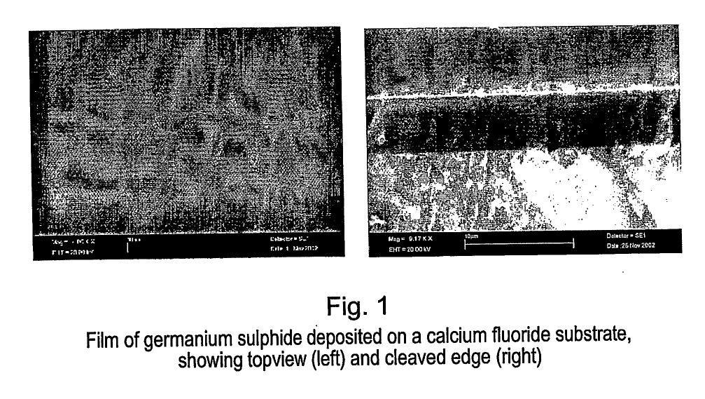

To illustrate the capability of the process of the present invention for deposition of chalcogenide thin films, germanium sulphide glass thin films were directly deposited onto a planar calcium fluoride substrate using a chemical vapour deposition process as shown in FIG. 1. This invention shows that the reaction of germanium tetrachloride (GeCl₄) as a precursor, with hydrogen sulphide (H₂S) which is co-delivered with the GeCl₄ into a heated furnace, is thermodynamically favourable to produce germanium sulphide glass film at atmospheric pressure and temperatures of about 500° C. Moreover we have demonstrated that the reaction produces germanium sulphide in a glass phase in a single deposition step.

The reactor used in the experiment is a 16 mm O.D.×500 mm long quartz tube, which is located within a horizontal tube furnace, which is resistively heated. One skilled in the art would recognise this as typical of a hot wall CVD process in which deposition occurs on all surfaces that are at a suitable temperature. A further refinement of this example, without loss of the effectiveness of the present case embodies a cold wall reactor in which deposition takes place only on the heated substrate.

The flow rate for the argon (Ar) carrier gas was 100 ml/min and was monitored and controlled by a mass flow controller. The carrier was bubbled through the germanium tetrachloride precursor (GeCl₄) and its vapours were carried by the argon gas into a mixing region. Separately, hydrogen sulphide (H₂S) gas was delivered, again through a mass flow controller to the mixing region at a rate of 20 ml/min. The connection tubes for the precursor and the tube for hydrogen sulphide are ¼ inch PFA tube, which entered a silica glass mixing region located immediately before the heated reaction chamber. These flow rates provided a molar ration of approximately 2.5 to 1 for H₂S to GeCl₄. This provided a slight excess of H2S for the reaction, which ensured that all the GeCl₄ was consumed by the reaction. The precursor, germanium tetrachloride (GeCl₄), is 99.9999% commercially available for silica MCVD process and the H₂S gas is from a commercial source but undergoes purification before entering the reactive chamber. The quartz reactor was fixed inside a resistance heated tube furnace with a temperature controller and maintained at 500° C. Within the reactor a calcium fluoride (CaF₂) substrate was placed with it planar face in line with the flow of the precursors. The flow rate of the carrier gases determines the reaction efficiency of the deposition process and the thickness of the resulting films depends on the deposition time. For one skilled in the art, it is a simple matter to calibrate the deposition rate to yield any desired thickness. In this example our objective was to produce films with a thickness sufficient to provide a thin film optical waveguide operating at single mode for wavelengths of 1.5 microns.

Deposition took place for a total of 30 minutes after which the flow of H₂S and GeCl₄ was stopped. The inert carrier gas Ar continued to flow as the furnace was cooled to room temperature. Upon removal from the furnace, the amorphous thin film was dense and adherent to the substrate. Visual inspection revealed good thin film interference colours indicated that the desired thickness was approximated. No reaction of the substrate was observed. As the thermal expansion coefficient of the germanium sulphide glass is about 15-25×10⁻⁶/K, a calcium fluoride substrate with a thermal expansion coefficient 18.9×10⁻⁶/K, a transmission range 0.13 to 10 μm, a refractive index about 1.43 @ 1.5 μm, and a melting point 1360° C. and is ideally suited for this experiment. A thermally incompatible substrate would result in cracked films.

Characterisation of the thin films deposited on the substrate began with imaging by scanning electron microscope (SEM). Images from the top and cleaved edge of the germanium sulphide glass on CaF₂ are shown in FIG. 1. They show a defect and crack free thin film, free of any obvious inhomogeniety. A film thickness of 7.5 microns is measured which corresponds to a deposition rate of 15 microns per minute. By SEM-EDX technique, the composition of the germanium sulphide glass is GeS_{1.72±0.02}.

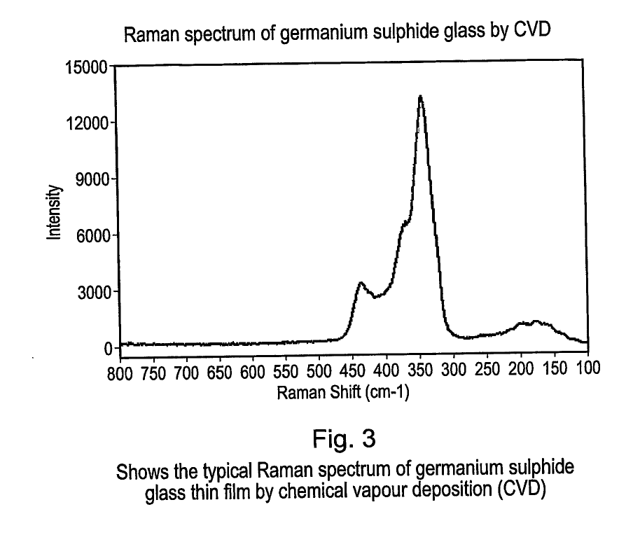

Qualitative characterisation of the deposited thin films continued using Raman spectroscopy. The Raman spectrometer used is RENISHAW Ramascope, a micro Raman with a CCD camera. A 633 nm He—Ne laser was used as the source to excite the scattering light from the sample. Then the scattering light collected by a microscope objective, selected by a grating, and measured by a detector. The measured Raman spectrum of deposited thin film is shown in FIG. 3. From this experimental measurement and with reference to [13] we can determine the approximate germanium to sulphur ratio with is approximately 1.7-1.8 and that an amorphous or glassy thin film was achieved.

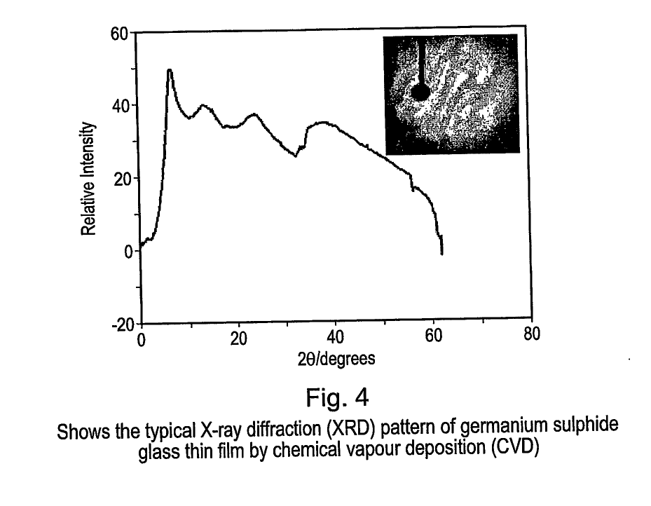

An X-ray diffraction (XRD) measurement, shown in FIG. 4 indicates no significant crystalline peak. From this pattern, we can also verify that the germanium sulphide glass film is amorphous and is of glassy phase.

This example illustrates that amorphous germanium sulphide thin films can be produced by the process of the present invention.

### EXAMPLE 2

### Channel Optical Waveguides

To illustrate the capability of this invention for the formation of optoelectronic device applications and in particular optical waveguide circuitry capable of guiding and manipulating light channel optical waveguides have been achieved. We have successfully fabricated patterned structures, in this case ridge waveguides in the glass films produced by the process disclosed in this invention.

Thin films as fabricated in example one were patterned and milled to produce waveguide channels. The process exploited both photolithography and argon ion-beam milling, which one skilled in the art would recognise as an important fabrication prerequisite for optoelectronic circuitry. In the photolithography process, we use a positive Shipley S1813 photoresist and Puddle MF319 developer. One drop of Shipley S1813 photoresist was spin coated at 6000 rpm for 60 seconds on a germanium sulphide thin film. This film was baked at 90° C. for 30 minutes before exposure to UV light through a mask, which defined the straight, parallel channels desired. UV exposure took place for 9.5 seconds and the photoresist was then developed for 45 seconds using Puddle MF391 developer. This resulted in patterned photoresist of approximately 1 micron thickness.

After the photolithography process, an Ar ion-beam milling instrument was used to etch the patterned thin film germanium sulphide glass waveguide. The Ar ion-beam has a non-selective property and therefore etched the photoresist and germanium sulphide glass at the same time. The etching rate was observed to be about 30 nm/min therefore a run time of 30 minutes was used. Finally, any residual photoresist was removed with acetone and rinsed clean with distilled water.

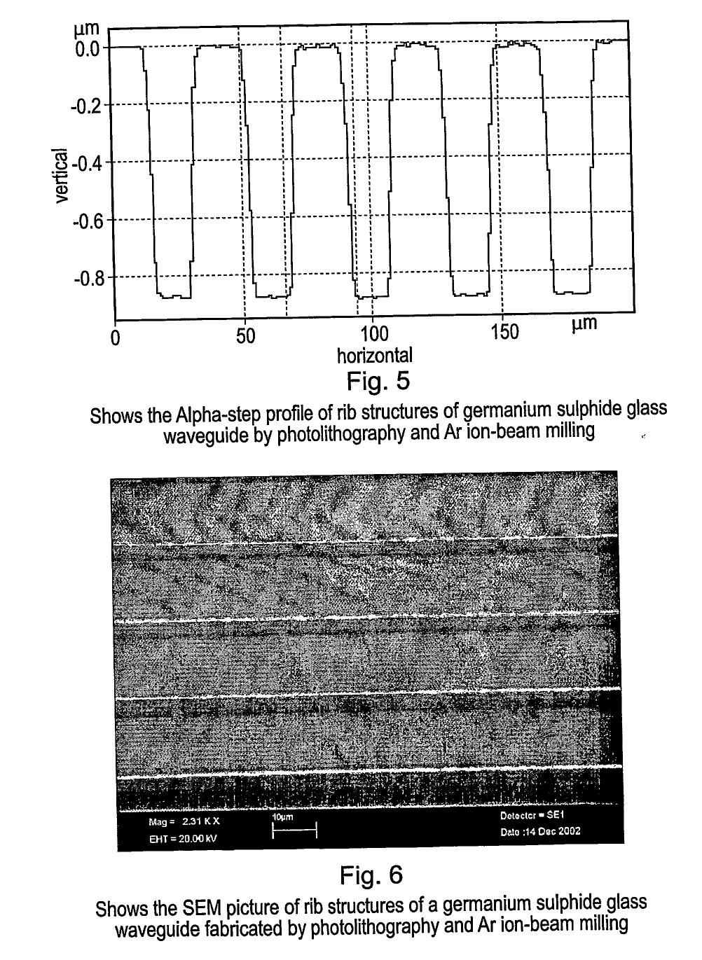

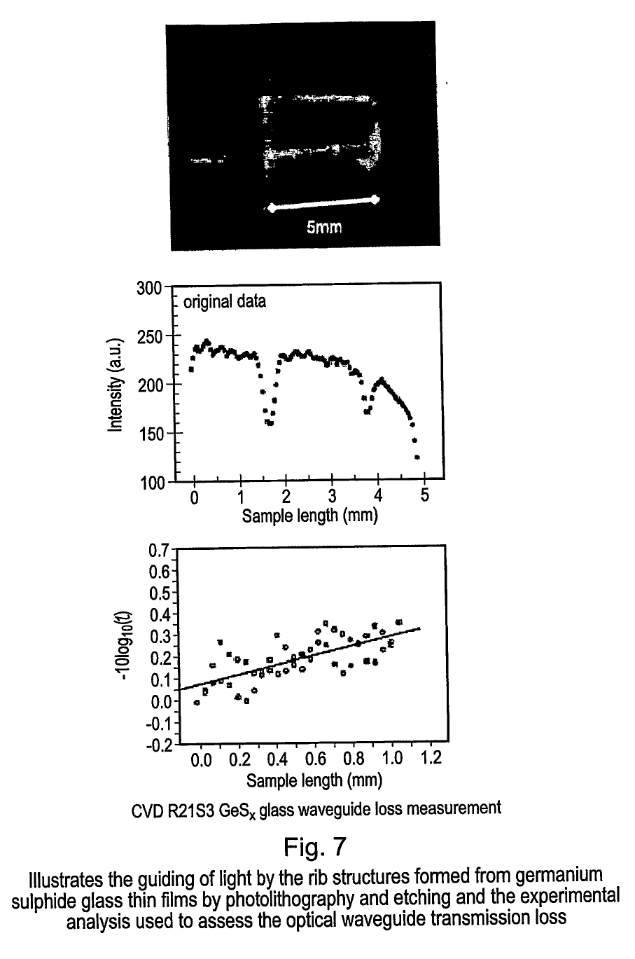

An alpha-step surface profiler was used to measure the resulting surface structures as shown in FIG. 5. From FIG. 5, we can find that the heights of the ribs are about 880 nm with spacing of about 28 microns. In FIG. 6 these rib waveguides are imaged using a scanning electron microscope. In FIG. 7, the guiding of light by these channels is verified. One skilled in the art can use well-know evaluation techniques to determine the transmission loss of the waveguide. Analysis of the scattered light intensity from the waveguide revealed a loss of 2.1 dB/cm.

This example illustrates that practical optical channel waveguides can be formed by the process of this invention.

### EXAMPLE 3

### Bulk Glass Fabrication

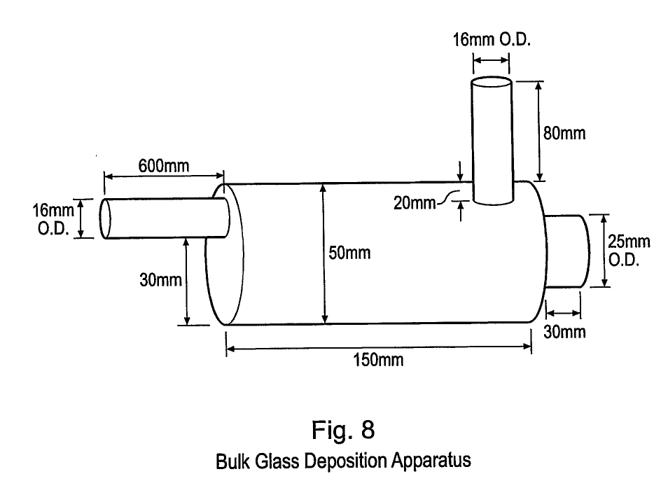

In this example we show formation of germanium sulphide powder that is melted in situ to form an amorphous solid or bulk glass. The apparatus is illustrated FIG. 8.

The reactor used in the experiment is a custom build borosilicate chamber of dimensions 50 mm O.D. and 150 mm long that is partially located within a vertical tube furnace that is resistively heated. This is not typical of a conventional CVD reactor that is useful for thin film deposition. Here there is a second collection vessel, which is an integral part of the entire apparatus and which is heated separately and the provision for both an open flowing atmosphere, operating at ambient pressure or slightly above ambient pressure and well as the provision for heating, after the CVD process is completed, to a temperature above the melting temperature of the CVD products.

During the deposition phase of the experiment, a flow rate for the argon (Ar) carrier gas was 100 ml/min and was monitored and controlled by a mass flow controller. The carrier was bubbled through the germanium tetrachloride precursor (GeCl₄) and its vapours were carried by the argon gas into a mixing region. Separately, hydrogen sulphide (H2S) gas was delivered, again through a mass flow controller to the mixing region. The flow rate of both compounds was 100 ml/min. The connection tubes for the precursor and the tube for hydrogen sulphide are ¼ inch PFA tube, which entered a silica glass mixing region located immediately before the heated reaction chamber. These flow rates provided a molar ration of approximately 2.5 to 1 for H2S to GeCl4. This provided a slight excess of H2S for the reaction, which ensured that all the GeCl4 was consumed by the reaction. The precursor, germanium tetrachloride (GeCl₄), is 99.9999% commercially available for silica MCVD process and the H₂S gas is from a commercial source but undergoes purification before entering the reactive chamber. The quartz reactor was fixed inside the resistance heated tube furnace with a temperature controller and maintained at 650° C.+/−50° C.

Deposition took place for a total of 15 hours during which time crystalline germanium sulphide was deposited as a powder throughout the chamber. When sufficient powder was collected the flow of H₂S and GeCl₄ was stopped, the system evaluated to a pressure typically 4×10₋₆ mbar and the chamber sealed. One of ordinary skill would recognise that there are a number of methods to seal the chamber at the desired pressure. This could simply be through the sealing of the input and output ports by glass blowing or through the use of valves.

After sealing the entire chamber is heated, using both the vertical tube furnace and the secondary heating elements. These secondary heating elements can simply be formed by the use resistively heated tape and a suitable temperature controller. A temperature of 900° C. was used which is above the melting temperature of the germanium sulphide powder. When this temperature is reached and maintained, the molten germanium sulphide flows under gravity to fill the collection vessel. In this example, the desired form of the bulk glass is a cylindrical rod hence the shape of the collection vessel matches this requirement.

The temperature of 900° C. was held for 2 hours during which time the molten germanium sulphide homogenised through natural convection currents in the melt. After which heating was stopped and the chamber allowed to cool rapidly. Following cooling, the collection vessel was slowly heated to an annealing temperature of 350° C. held for 8 hours and then slowly cooled to room temperature. This annealing phase insured any residual stress within the glass is relieved. Upon cooling the chamber is opened and the solid cylindrical glass sample removed.

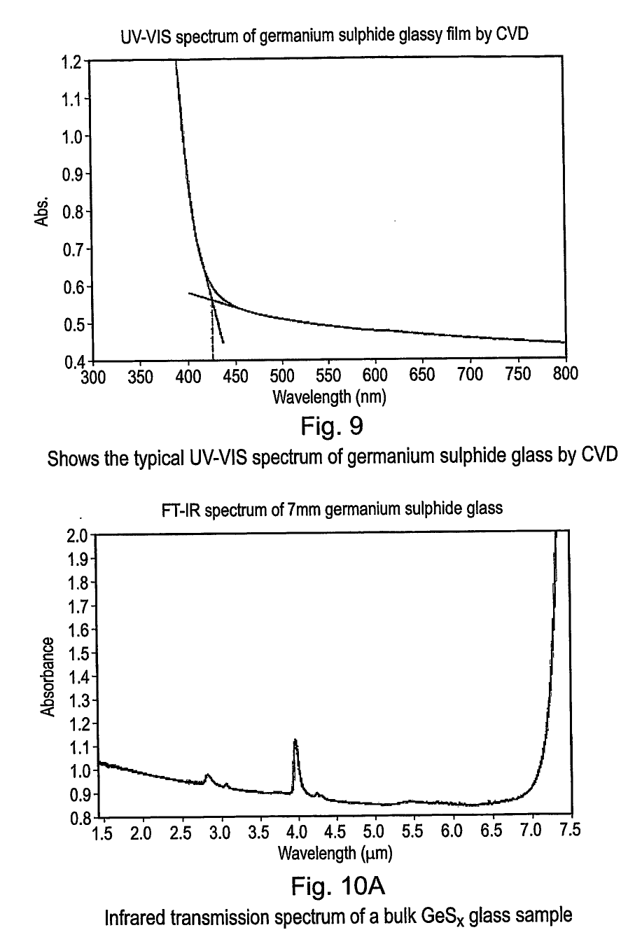

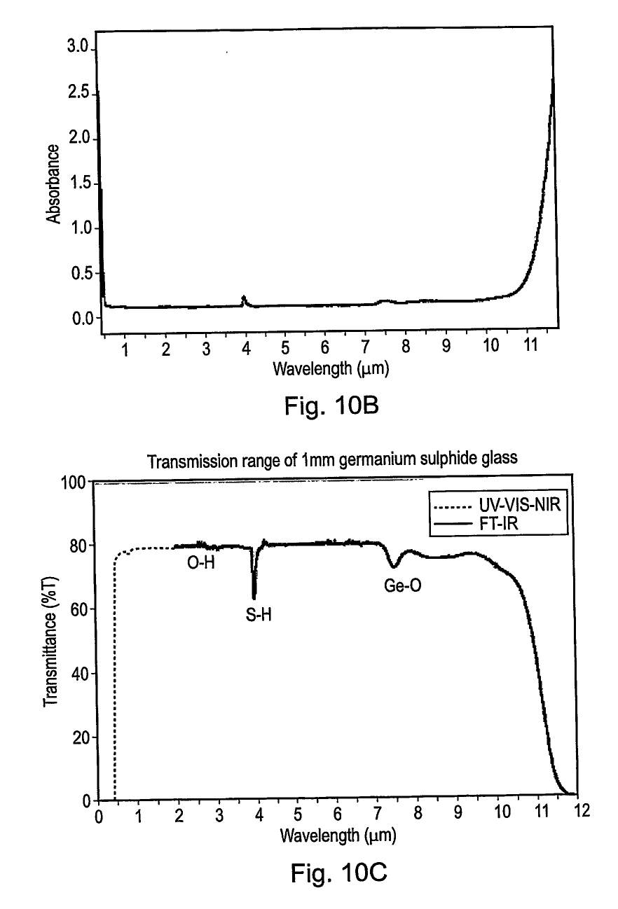

To characterise the glass produced, various analytical tools are used. The transmission spectrum of the glass was obtained by the use of a Varian Gary 500 Scan UV-VIS-NIR spectrophotometer and the measurement result is shown in FIG. 9. From the transmission spectrum we can see that the glass is a transparent at visible and near infrared wavelengths, we can estimate that the germanium sulphide glass has an absorption edge at ˜425 nm (2.9 eV) which is characteristic of semiconductors. Similar spectroscopic measurement in the infrared spectrum, FIG. 10A, shows transmission to 7 microns with two small impurity absorption bands at around 3 and 4 microns. These represent trace levels of OH⁻ and SH⁻. FIG. 10B is a similar plot for another sample. FIG. 10C shows the transmittance of a sample.

In order to analyse the thermal properties of germanium sulphide glass, a differential thermal analyser (DTA), Perkin-Elmer DTA7 was used. Here a small test sample of the glass is slowly heated while its temperature relative to an inert control sample is monitored. Differences in the temperature reveal the points at which endothermic and exothermic changes in glass phase take place, revealing the thermal characteristics of the glass. During this measurement nitrogen purging gas at a flow rate of 20 ml/min was used. The temperature profile was initially held at 50° C. for 1 min, heating up to 300° C. at a rate of 40° C./min, holding at 300° C. for 20 mins, and then heating up to 900° C. at a rate of 10° C./min.

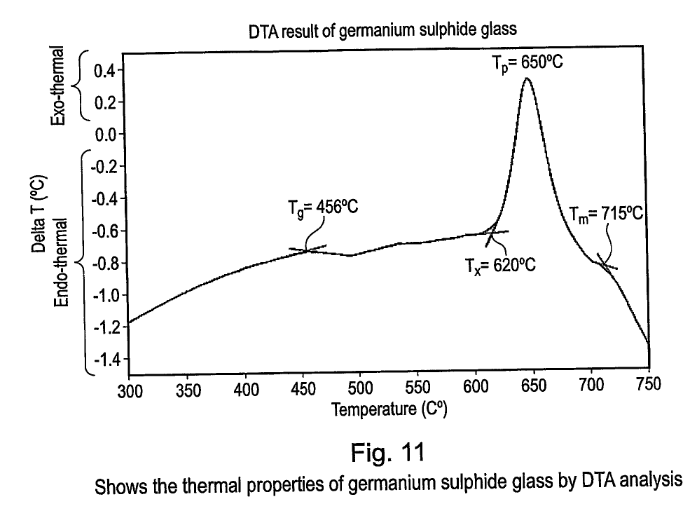

The DTA result of germanium sulphide glass by our CVD experiment is shown in the FIG. 11. The data reveals a glass transition temperature (T_{g}) of 456° C., a peak crystallisation temperature (Tₚ) of 650° C., a melting temperature (Tₘ) of 715° C., and the onset of crystallisation (Tₓ) at 620° C. These indicate a thermally stable chalcogenide glass which can be used at up to 450° C. without risk of crystallisation of the glass.

To determine the purity of the bulk glass, independent compositional analysis was undertaken by an outside contractor. The process of glow discharge mass spectrometry was used to analyse typical impurity elements and the results shown in table 2.

TABLE 2
Compositional analysis of bulk glass formed by
the process of this invention

| Element | Concentration | Element | Concentration |
|---|---|---|---|
| C | <=0.6 | V | <0.005 |
| O | <=460 | Cr | <0.005 |
| Na | <0.005 | Mn | <0.01 |
| Mg | 0.02 | Fe | <0.05 |
| Al | 0.17 | Co | <0.005 |
| Si | 4.0 | Ni | <0.05 |
| S | Matrix | Cu | <0.05 |
| Cl | 65 | Zn | <0.05 |
| K | <0.05 | Ga | <0.05 |
| Ca | <0.05 | Ge | Matrix |
| Ti | <0.005 | Ce | <0.005 |

One skilled in the art would recognise that the low levels of transition metal impurities (Ti, V, Cr, Mn, Fe, Co, Ni, Cu) measured here to be much less 1 ppm are very favourable for an optoelectronic material and significantly better than the impurity levels achieved in chalcogenide glasses prepared by conventional methods.

This example illustrated that the process of this invention can be used to realise a high purity germanium sulphide based chalcogenide glass.

### EXAMPLE 4

### Modified Sulphide Glasses

One skilled in the art would recognise that are a wide variety of metal halide salts which could replace or supplement the use of GeCl₄. These include, but are not limited to the compounds listed below in table 3. Many of these are liquid at room temperature and thus ideally suited for the present method. Others can easily be molten in situ and carried as a vapour to the reaction chamber.

TABLE 3
Modifiers which can be incorporated in germanium sulphide glass

| Metal | Melting | Metal | Melting | Metal | Melting | Metal | Melting |
|---|---|---|---|---|---|---|---|
| chlorides | point(° C.) | chlorides | point(° C.) | chlorides | point(° C.) | chlorides | point(° C.) |
| TlCl | 430 | NbCl₅ | 208.3 | HfCl₄ | 320 | BiCl₃ | 230-232 |
| TeCl₄ | 224 | NdCl₃ | 784 | AuCl | 170 | BaCl₂ | 963 |
| TaCl₅ | 216 | MoCl₃ | 194 | GeCl₄ | −49.5 | NaCl | 801 |
| SiCl₄ | −70 | HgCl₂ | 277 | GdCl₃ | 609 | AlCl₃ | 190 |
| Se₂Cl₂ | −85 | MnCl₂ | 650 | ErCl₃ | 774 | PCl₃ | −111.8 |
| RuCl₃ | >500 | MgCl₂ | 714 | DyCl₃ | 718 | KCl | 773 |
| RbCl | 718 | LuCl₃ | 905 | CuCl₂ | 100 | CaCl₂ | 782 |
| RhCl | 450 | LiCl | 605 | CuCl | 430 | GaCl₃ | 77.9 |
| PrCl₃ | 786 | PbCl₂ | 501 | CoCl₂ | 735 | SnCl₃ | 37-38 |
| PtCl₂ | 581 | LaCl₃ | 806 | CrCl₂ | 824 | TmCl₃ | 824 |
| PdCl₅ | 675 | FeCl₃ | 674 | CsCl | 646 | YCl₃ | 721 |
| InCl₃ | 586 | IrCl₃ | 763 | CdCl₂ | 568 | AsCl₃ | −16 |
| WCl₆ | 275 | HoCl₃ | 718 | SbCl₃ | 73.4 | ZrCl₄ | 331 |
| TiCl₄ | −25 | ZnCl₂ | 283 | VCl₄ | −28 | AgCl | 455 |

Furthermore, for active devices, it is desirable to include low levels of some dopant ions, in particular the transition metals (Ti, V, Cr, Mn, Fe, Co, Ni, Cu) and the lanthanides (Ce, Pr, Nd, Pm, Sm, Eu, Gd, Tb, Dy, Ho, Er, Tm, Yr, Lu) for their absorption and emission properties.

### EXAMPLE 5

### Conformal Coatings

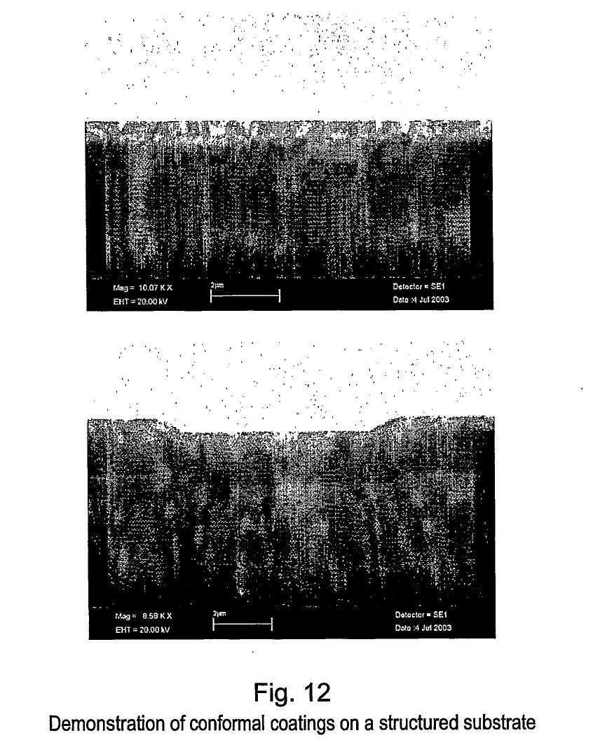

It is desirable that a deposited film conform to any intentional surface features on the surface of the substrate. We have used the method of examples one and five to demonstrate such conformal coatings, as shown in FIG. 12.

### EXAMPLE 6

### Other Substrate Materials

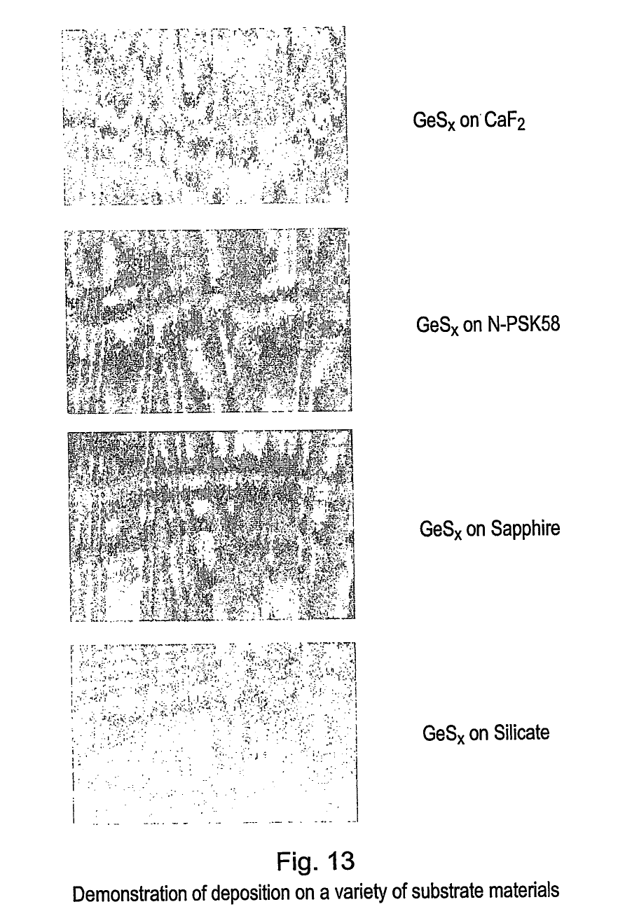

It follows from example one that the present invention provides the ability to coat difference substrates. We have identified a range of substrate materials which provide the required match in coefficient of thermal expansion. FIG. 13 illustrates the results of depositions according to the method of example one on CaF3, Schott N-PSK58 glass, sapphire and silicate glass.

### EXAMPLE 7

### Cold Wall Reactor

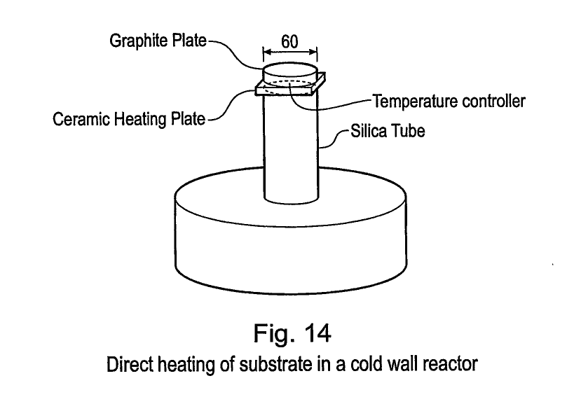

It can be desirable to heat only the substrate such that deposition is limited to the surface area of the substrate. The apparatus in FIG. 14 illustrates our method in which a 60 mm ceramic heater is mounted on a silica tube, which suspends the heater and substrate within the reaction chamber. No other heat source is used and deposition is limited to the heated substrate area.

### APPLICATIONS

Chalcogenides are a unique optical material in the wide range of applications they provide. These properties include its transparency both in the visible and the infrared (0.5-7 microns, non-toxicity, high softening temperature, ease of fabrication, optical quality, chemical stability, and isotropic properties, make it attractive for many device applications. These applications are best illustrated by identification of the material properties that can be exploited for various applications.

Chalcogenide glasses transmit to infrared wavelengths far beyond the absorption edge of traditional oxide based glasses providing application as Infrared materials, including IR windows, lenses and other related optical components. Specifically, applications are found for wavelength ranges between approximately 0.5 and 7 microns.

This infrared transmission allows the fabrication of infrared waveguides, including structures based on thin films, planar waveguides, and optical fibres, including holey optical fibres for typical applications from approximately 1 to 5 microns. These waveguides find application in medical, sensing, remote spectroscopy, temperature monitoring and thermal imaging to name only some representative examples. Infrared optical waveguides for applications that exploit the atmospheric transmission windows around 2.5 and 4.1 microns, particularly for defence and aerospace applications [2].

Germanium sulphide based glass has the ability to incorporate of rare-earth, transition metals and other dopants at a controlled and predetermined doping level. Among other effects these dopants provide fluorescence, which be exploited to create a optical source, fluorescence, superfluorescent, optical amplifier or laser source. Chalogenides are family of glasses which can be classified spectroscopically as low phonon energy materials, typically made from heavy weakly bound elements, reduce the probability of the non-radiative decay of an excited rare earth ion, increasing, for example, optical amplifier efficiencies [14].

Other active devices based on germanium sulphide based glass can exploit its superior acousto-optic. In this effect an ultrasonic wave induces refractive index changes via the photoelastic effect, with the changes in the germanium sulphide based glass having the same periodicity, amplitude and phase modulation of the acoustic wave [15].

Chalcogenide glasses, including germanium sulphide based glasses have a large Faraday effect, unlike other glasses, which is temperature independent. The Faraday effect is the phenomenon in which the plane of polarisation of a light beam through a material is rotated when the material is placed in a magnetic field. Glasses with a large Faraday effect are promising materials for magneto-optical switches, modulators, optical circulators, magnetic and electric field sensors and as nonreciprocal elements in laser gyroscopes [16].

Germanium sulphide is a photosensitive glass, that is exposure to light results in a photo-induced change in the linear refractive index of the glass which results when the illumination generates a space charge field that modulates the refractive index via the electro-optic effect. These can be either permanent or temporary changes. Photo-induced phenomenon in chalcogenide glasses has been a positive property with a variety of applications from a technological viewpoint. Specific photo-induced changes include a photo induced phase change, photo-darkening, photobleaching, photo-induced a anisotropy and photoelectro-ionic processes [17].

Applications of photo-induced phenomenon include thick films for holographic data storage erasable holographic memories and phase change memory [18-19].

Nonlinearity is a photoinduced second or higher order change in the linear refractive index of a glass. The refractive nonlinearity results for germanium sulphide based glasses show values over one hundred times that of more conventional silica-based glasses. A number of nonlinear phenomenon including ultrafast switching, spectral broadening, nonlinear pulse propagation, frequency conversion and four-wave mixing, stimulated Brillouin and Raman scattering, super continuum generation, to name a few [21] have been demonstrated in highly nonlinear materials such as chalcogenide glasses.

Chalcogenides are well established in the research laboratory where work is actively being pursued for telecommunication applications based on many of these non-linear and other properties [22-23].

Among emerging applications, thin films produced from chalcogenide films find application as photonic crystal waveguides. A wide range of chemical and biological sensors based on chalcogenide thin film technology are under development [24].

The thin film material is suitable for optical memory applications, for example by depositing a thin film of germanium sulphide on a substrate that can be any suitable planar surface including silicon, calcium fluoride or such like. The phase of a finite area of the film can be switched between the amorphous and crystalline state though the exposure to light of any wavelength, e.g. by localised heating of that area. A holographic memory can be produced from a thin film where a localised change of the refractive index can be achieved through the exposure of interfering coherent light sources.

Channel waveguides can also be directly written into thin films of germanium sulphide. The channel waveguide can be inscribed into the thin film by means of a coherent laser light source at any wavelength. This can be used for an optical amplifier or laser [25], optical switch, sensor or interferometer, for example. Some device examples are now given.

1. Passive Devices

(a) Single Mode Optical Fibres in germanium sulphide: An optical fibre may advantageously have both a core and clad made of germanium sulphide. However, germanium sulphide may be used only for the core (or clad) and a different glass may be used for the clad (or core). The different glass is preferably thermally and chemically compatible to germanium sulphide.

(b) Optical Fibre for Long Wavelengths (e.g. 1-10 microns): Use can be made of the low absorption in the infrared of germanium sulphide. In particular, germanium sulphide may be transparent in the 3-5 micron atmospheric transmission window (including CO absorption and emission wavelengths).

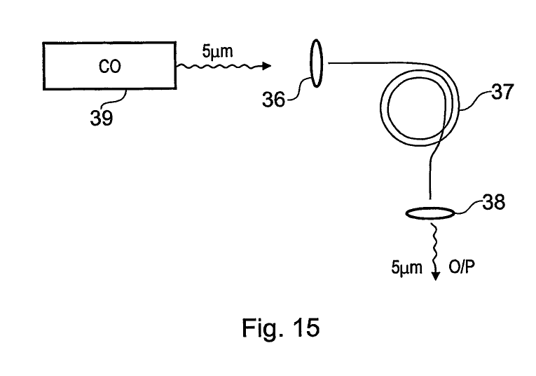

FIG. 15 shows use of a germanium sulphide optical fibre for high power transfer of output from a CO laser 39 which may be used for machining, aerospace or sensor applications. The laser output beam at 5 microns wavelength is coupled into and out of a germanium sulphide fibre 37 with suitable lenses 36 and 38.

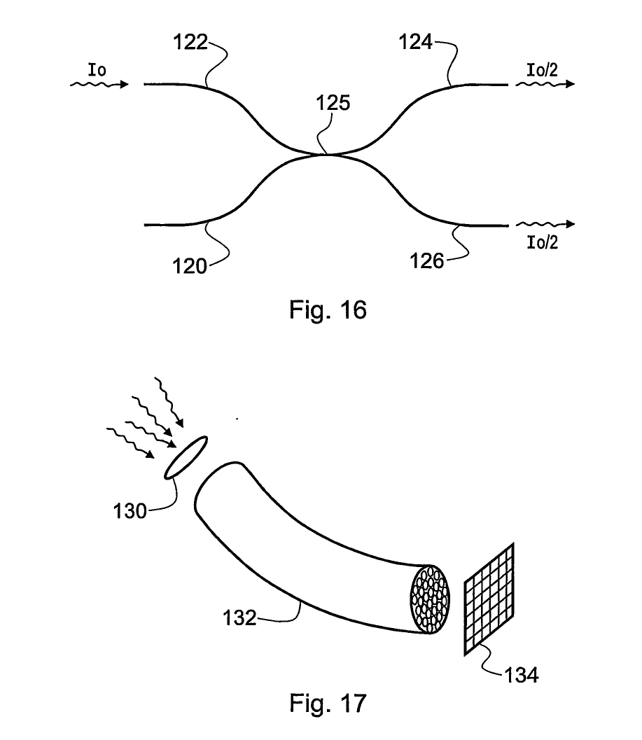

(c) Couplers, Splitters etc: In principle, germanium sulphide fibres could allow the full range of fibre components to be extended to the infrared. An exemplary 50:50 fused coupler is shown in FIG. 16. A fused region 125 interconnects arms 120, 122, 124 and 126, with an input light beam of intensity lo being split into two beams of half intensity I₀/2.

(d) Infrared Thermal Imaging: germanium sulphide fibres could be used in a range of thermal imaging applications. FIG. 17 shows a germanium sulphide fibre bundle 132 used to channel light from an imaging lens 130 to a detector array 134 which will be connected to image processing electronics (not shown).

2. Active Devices

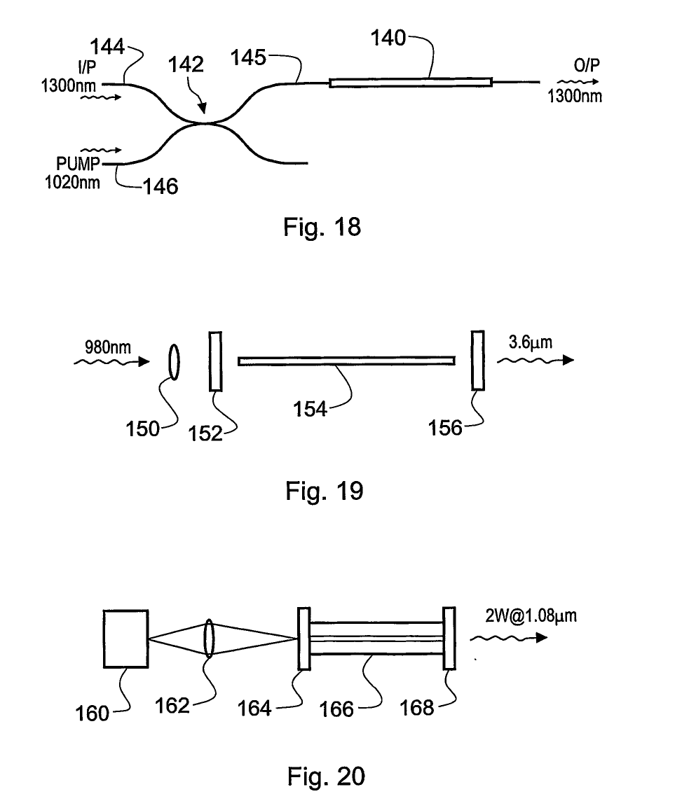

(a) 1300 nm Optical Amplifier: FIG. 18 shows a 1300 nm band rare-earth doped holey germanium sulphide fibre amplifier. Pump radiation at 1020 nm from a laser diode and a 1300 nm input signal are supplied to fused coupler input arms 144 and 146, and mixed in a fused region 142 of the coupler. A portion of the mixed pump and signal light is supplied by an output arm 145 of the coupler to a section of Pr³⁺-doped germanium sulphide fibre 140 where it is amplified and output. Other rare-earth dopants such as Nd or Dy could also be used with an appropriate choice of pump wavelength.

(b) Infrared Fibre Laser With germanium sulphide, a new range of laser transitions become efficient and viable, so germanium sulphide fibres have potential for use as gain media in laser sources. Some examples include using lines at 3.6 and 4.5 microns (Er), 5.1 microns (Nd³⁺), 3.4 microns (Pr³⁺), 4.3 microns (Dy³⁺), etc. These transitions could be exploited in a range of lasers, including continuous wave, Q-switched, and mode-locked lasers. In addition, any of the usual rare-earth dopants could be considered depending on the wavelengths desired.

FIG. 19 shows one example of an infrared fibre laser in the form of a laser having an erbium-doped germanium sulphide fibre gain medium 154 bounded by a cavity defined by a dichroic mirror 152 and output coupler 156. Pump radiation at 980 nm from a laser diode (not shown) is supplied to the cavity through a suitable lens 150. The laser produces a 3.6 micron laser output. It will be appreciated that other forms of cavity mirrors could be used, e.g. in-fibre Bragg grating reflectors.

(c) High-Power Cladding Pumped Laser: The higher index contrast possible in germanium sulphide fibres allows for fibres with very high numerical aperture (NA) of well in excess of unity. It is therefore possible to provide improved pump confinement and thus tighter focusing, shorter devices, lower thresholds etc.

FIG. 20 shows one example in the form of a cladding pumped laser having a germanium sulphide fibre gain medium 166 doped with Nd. A pump source is provided in the form of a high-power broad-stripe diode 60 of 10 W total output power at 815 nm. The pump source is coupled into the gain medium through a focusing lens 162 and the cavity is formed by a dichroic mirror 164 and output coupler 168 to provide high-power, multiwatt laser output at 1.08 microns.

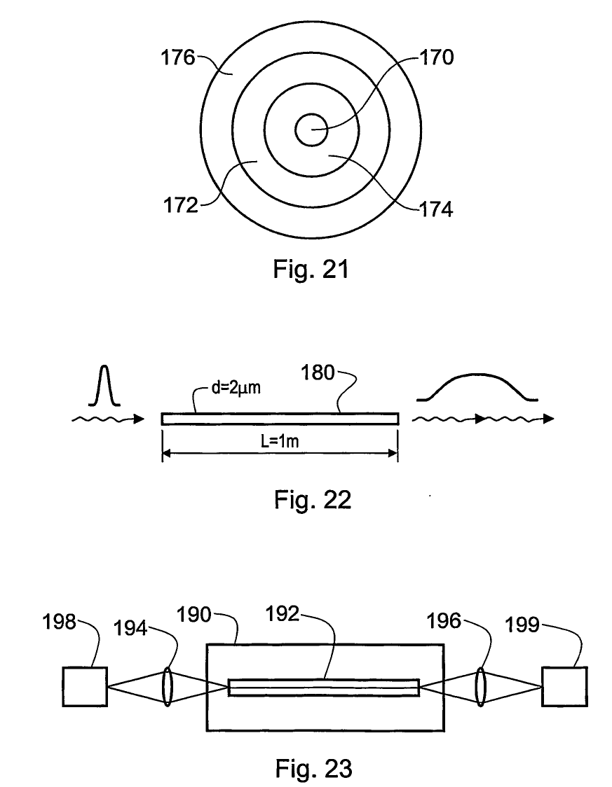

FIG. 21 shows in cross-section one possible implementation of the Nd-doped germanium sulphide fibre of the laser of FIG. 20. A Nd-doped solid core 170 of diameter ‘d’ and radius ‘r1’ is surrounded by an inner cladding 174 extending to a radius ‘r2’ from the centre of the fibre. This inner cladding is surrounded by an outer cladding 172 of diameter ‘d2’ extending out to a radius ‘r3’ from the fibre centre axis. Finally, the entire fibre is encased by a low-index polymer coating 176. The polymer is advantageously doped with a dopant that exhibits absorption at a transmission wavelength of the germanium sulphide fibre which it is desired to be stripped from the cladding. Graphite can be suitable for this purpose, as can transition metals such as Ti, V, Cr, Mn, Fe, Co, Ni or Cu, and rare earth ions such as Pr, Nd, Sm, Th, Dy, Ho, Er, Tm or Yb. Typically, r1 is a few microns and r2 is about 100-200 microns in order to match the output of the pump diode. The different refractive indices of the core, inner cladding and outer cladding serve to provide a graded index profile.

3. Non-linearity

(a) Highly non-linear fibre for switching applications. When the higher third order refractive index constant n₂ typical of germanium sulphide is combined with the high degree of mode confinement achievable with holey fibre, germanium sulphide fibres could exhibit up to 10000 times the non-linearity of conventional silica fibre. Extremely short fibre based non-linear devices could thus be made for telecom power pulses.

FIG. 22 shows an example non-linear device used for spectral broadening of pulses. For example, consider a germanium sulphide holey fibre with a small core diameter of 2 microns, length 1 meter and n₂ of about 100 times that of silica. The propagation of an initially transform limited Gaussian pulse of approx. 1.7 W peak power in 1 m of fibre should result in a 10-fold spectral broadening, for example from 1 to 10 nm pulse half width. Alternatively, one can express the above example in terms of a maximal phase shift at the pulse centre i.e. a 1.7 W Gaussian pulse will generate a peak non-linear phase shift of 8.6 radians after propagation through 1 m of fibre. Note that both of the above calculations neglect the effect of fibre dispersion. Dispersion can play a significant role in the non-linear propagation of a short optical pulse and can for example result in effects such as soliton generation. Germanium sulphide fibres offer for example the possibility of soliton formation at wavelengths not possible with conventional silica fibres.

A range of possibilities exist for using these fibres as the basis for a variety of non-linear optical switches. These include Kerr-gate based switches, Sagnac loop mirrors, non-linear amplifying loop mirrors or any other form of silica fibre based non-linear switches (see reference [26], the contents of which is incorporated herein by reference).

(b) Gas Sensing Applications

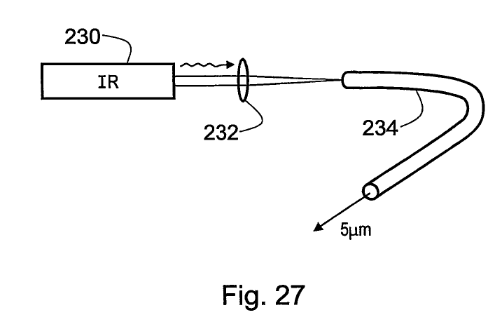

FIG. 27 shows a sensing device including a germanium sulphide holey fibre 192. The germanium sulphide holey fibre is arranged in a gas container 190, containing CO₂ gas, for example. A light source 198 is arranged to couple light into the germanium sulphide fibre via a coupling lens 194 through a window in the gas container. Light is coupled out of the gas container through a further lens 196 and to a detector 199. The detector will register presence of a particular gas through an absorption measurement of the light (for example, absorption of light at 4.2 microns for the detection of CO₂).

4. Photosensitivity

(a) Fibre gratings for Infrared: Making use of the photosensitivity of germanium sulphide, gratings can be written using light at longer wavelengths than the conventional UV wavelengths used for writing gratings into silica fibre. The writing beam can be at 633 nm, for example. Techniques developed for writing gratings in silica glass can be adopted, such as stroboscopic phase mask methods [27], interferometer methods [28] or proximity phase mask methods [29], the contents of these references being incorporated herein by reference. Fibre Bragg grating technology can thus be extended to the infrared/mid infrared. The high index contrast between modes of germanium sulphide fibre structures also has the advantage of enhancing the separation and control of cladding modes.

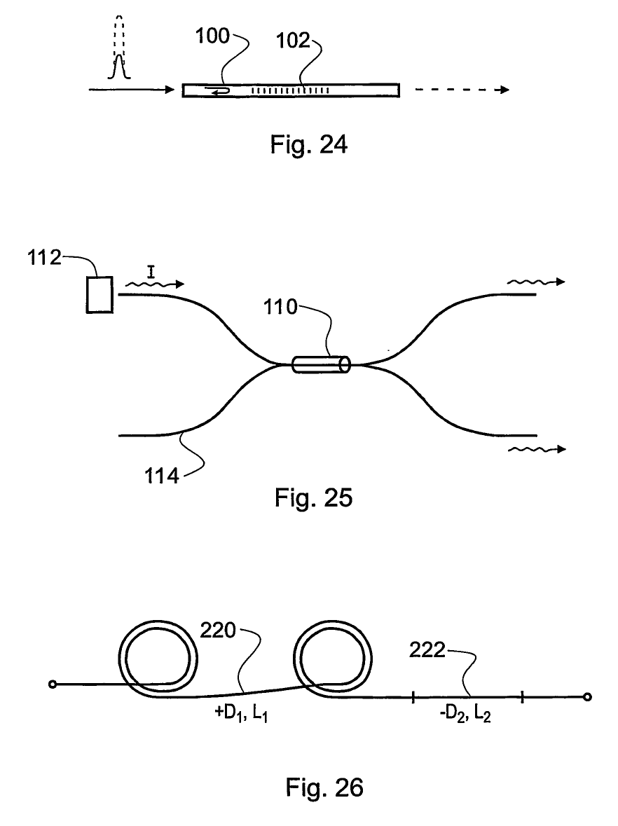

(b) Non-linear grating based devices: High non-linearity should allow for low threshold grating based devices (logic gates, pulse compressor and generators, switches etc.). For example, FIG. 24 shows an optical switch based on a germanium sulphide fibre 100 made with a small core diameter of around 1-2 microns and incorporating an optically written grating 102. In operation, pulses at low power (solid lines in the figure) are reflected from the grating, whereas higher power pulses (dashed lines in the figure) are transmitted due to detuning of the grating band gap through Kerr non-linearity.

5. Acoustic Devices

More efficient fibre acousto-optic (AO) devices can be fabricated. The acoustic figure of merit in germanium sulphide is expected to be as much as 100-1000 times that of silica. This opens the possibility of more efficient fibre AO devices such as AO-frequency shifters, switches etc. Passive stabilisation of pulsed lasers may also be provided. Microstructured fibres might also allow resonant enhancements for AO devices via matching of the scale of structural features to a fundamental/harmonic of the relevant acoustic modes. The use of germanium sulphide would also allow AO devices to be extended to the infrared.

FIG. 25 shows an AO device in the form of a null coupler based on germanium sulphide fibre. The device has the form of a null coupler 114 with a coupling region at which a piezoelectric transducer 110 is arranged for generating acoustic waves. In the absence of an acoustic wave, light I is coupled from a source 112 into one output arm of the coupler, whereas in the presence of the acoustic wave light is coupled into the other output of the coupler. Further details of devices of this kind can be found in references [30] and [31].

6. Dispersion Effects

Germanium sulphide holey fibres can provide engineerable dispersion in the infrared. In silica holey fibres, a range of highly unusual dispersive properties are possible (such as solitons in the visible, dispersion compensation, dispersion flattening). In germanium sulphide holey fibres, the dispersion could be tailored to allow a range of new possibilities in the infrared such as: solitons, efficient non-linear processes, parabolic pulse amplifiers etc.

FIG. 26 shows an example of a dispersion based device. A length L₂ of germanium sulphide holey fibre 222 is arranged in series in a transmission line comprising a length L₁ of silica fibre 220, for in-line dispersion compensation. The germanium sulphide holey fibre has strong negative dispersion (−D₂) to compensate for the weak positive dispersion (+D₁) in the transmission fibre, either as pre- or post-compensation. Such dispersion compensation is appropriate also for use in short pulse fibre lasers operating in the infrared.

7. Mode-Size

(a) High Power Handling Fibres for Infrared: Single mode germanium sulphide fibres with large cores, e.g. ˜0.5 mm, could find application in laser cutting, welding and machining. The hole spacing Λ is preferably much greater than the wavelength λ to be guided and the hole diameter d. In particular, d/Λ is preferably less than about 0.2, or than 0.1. The holey structure also provides improved cooling opportunities for high power operation. FIG. 27 shows use of such a fibre 234 for guiding output from a CO high power laser 230, also utilising a coupling lens 232 for coupling the laser light into the fibre.

It will be apparent to those skilled in the art that various modifications and variations can be made in the present invention without departing from the scope or spirit of the invention. Other embodiments of the invention will be apparent to those skilled in the art from consideration of the specification and practise of the invention disclosed herein. It is intended that the specifications, examples and applications be considered as exemplary only, with the true scope and spirit of the invention being indicated by the following claims.

### REFERENCES

[1] K. Hirao, T. Mitsuyu, J. Si, J. Qiu, “Active Glass for Photonic Devices” Springe-Verlag, Berlin, Ch. 6 Active Glasses for Functional Materials, pp. 188-193.
[2] Infrared Transmitting Fibre Optics, editors, Jas S. Sanghera and Ishwar D. Aggarwal, 450 pages (14 May, 1998) CRC Press
[3] P. J. Melling, “Alternative Methods of Preparing Chalcogenide Glasses”, Ceramic Bulletin, 63, 1427-1429, 1984.
[4] JP60108341
[5] JP60108326
[6] T. Katsuyama, S. Satoh and H. Matsumura, “Fabrication of high-purity chalcogenide glasses by chemical vapor deposition”, J. Appl. Phys. 59 (5), 1446-1449, 1 Mar. 1986.
[7] A. Macinnes et al, “Chemical Vapor Deposition of Cubic Gallium Sulfide Thin Films: A New Metastable Phase”, Chem. Mater. 4, 11-14, 1992.
[8] S. Schultz et al, “Synthesis of gallium chalcogenide cubanes and their use as CVD precursors for Ga(2)E(3)(E=S,Se)”, Organometallics 15 (22) 4880-4883 29 Oct. 29 1996.
[9] JP6122523
[10] WO-A-9914168
[11] WO-A-0068718
[12] D. Sheel and M. Pemble, “Atmospheric Pressure CVD Coatings on Glass”, ICCG4 November 2002.
[13] Physical Review B, vol.64, pp125-210
[14] D. W. Hewak, Editor, EMIS Data review series No. 22, Properties, Processing and Applications of Glass and Rare-Earth Doped Glasses for optical fibres, 1998, 366 pp.
[15] Abdulalim, I., C. N. Pannel et al, (1993), “High-Performance Acoustooptic Chalcogenide Glass Based on Ga2S3-La2S3 Systems”, J. Non-Crystalline Solids 166:1251-1254
[16] C. B. Pedroso et al, High Verdet constant Ga:S:La:O chalcogenide glasses for magneto-optical devices, pp. 214-219 Optical Engineering, February 1999 Vol. 38.
[17] Shimakawa K, Kolobov A, Elliott SR: Photoinduced effects and metastablity in amporphous semiconductors and insulators, Adv Phys 1995, 44: 475-588.
[18] M. Petrovich, A. K. Mairaj, D. W. Hewak, H. N. Rutt, “Temperature dependence of reversible photodarkening in Ga:La:S and Ga:La:S:O glass fibres”, XIX International Congress on Glass Edinburgh 1-6 Jul. 2001 2 pp.951-2
[19] Ohta T. Akahira N, Ohara S, Satoh I: High-density phase change optical recording, Optoelectronics 1995, 10:361-380
[20] D. W. Hall et al, Appl. Phys. Lett. 54, 14 (1989) 1293
[21] G. Agarwal, Applications in Nonlinear Fibre Optics, 444 pages (25 Jan., 2001) Academic Press; ISBN: 0120451441
[22] Switching Devices A. Saliminia et al, J. Lightwave Tech. 17 5 (1999) 837
[23] M. Asobe et al, Appl. Phys. Lett. 60, 10 (1992) 1153
[24] B. L. Seleznez, A. V. Legin and Yu G. Vlasov, “Chemical sensors in natural water: Behaviour features of Chalcogenide Glass Electrodes for Determining Copper, Lead and Cadmium Ions”, J. Analytic. Chemistry, Vol. 51, No. 8 1996 pp 813-817
[25] GB-A-2304978
[26] G. Agrawal, Nonlinear Fibre Optics, Academic Press (1995)
[27] WO-A-9808120
[28] U.S. Pat. No. 5,822,479
[29] EP-A-0843186
[30]T. A. Birks, S. G. Farwell, P. St. J. Russell & C. N. Pannell “Four-Port Fibre Frequency-Shifter with a Null Taper Coupler” Opt. Lett. Vol.19(23) pp.1964-1966 December 1994
[31] S. H. Yun, D. J. Richardson, D. O. Culverhouse and T. A. Birks “All-fibre acousto-optic filter with low polarization sensitivity and no frequency shift” IEEE Phot. Tech. Lett. 1997 Vol.9(4) pp.461-453)

1-42. (canceled)

43. A method of synthesising germanium sulphide using chemical vapour deposition, comprising:
(i) providing a gas mixture containing germanium tetrachloride (GeCl₄) and hydrogen sulphide (H₂S); and
(ii) passing the gas mixture into a reaction chamber that is operated to provide a reaction temperature of between 450-700° C. for the reaction:
GeCl₄+2H₂S [symbol] GeS₂+4HCl
thereby synthesising germanium sulphide in solid form and hydrogen chloride in gaseous form as a byproduct.

44. The method of claim 43, wherein the germanium sulphide is deposited as a glass film on a substrate arranged in the reaction chamber.

45. The method of claim 43, wherein the germanium sulphide is deposited as a glass film on the inside of a hollow tube that is one of arranged in, or forms part of, the reaction chamber.

46. The method of claim 44, wherein the composition of the glass film is varied during its deposition to provide a desired refractive index profile.

47. The method of claim 45, further comprising collapsing the reaction chamber to create an optical fibre preform in which the first glass film will form the cladding layer of the optical fibre and the second glass film will form the core.

48. The method of claim 47, further comprising drawing the optical fibre preform into an optical fibre.

49. The method of claim 43, wherein the reaction chamber is operated to provide a reaction temperature of 500° C.+/−50° C. to induce formation of the germanium sulphide in glass form through the reaction.

50. The method of claim 43, wherein the reaction chamber is operated to provide a reaction temperature between the temperature of glass transition and the temperature of onset of crystallisation of germanium sulphide to induce formation of the germanium sulphide in glass form through the reaction.

51. The method claim 43 wherein the reaction chamber is a horizontal tube furnace.

52. The method of claim 43 wherein the germanium sulphide is deposited in crystalline form in the reaction chamber.

53. The method of claim 52, further comprising:
sealing the reaction chamber containing the germanium sulphide in crystalline form; and
heating the sealed reaction chamber to melt the crystalline form of the germanium sulphide and resolidify it into glass.

54. The method of claim 52, wherein the reaction chamber is operated to provide a reaction temperature of 650° C.+/−50° C. to induce formation of the crystalline form of germanium sulphide through the reaction.

55. The method of claim 52, wherein the reaction chamber is operated to provide a reaction temperature between the temperature of onset of crystallisation of germanium sulphide and its melting temperature to induce formation of the germanium sulphide in crystalline form through the reaction.

56. The method claim 52 wherein the reaction chamber is a vertical tube furnace.

57. The method of claim 43, wherein the gas mixture is directed through a nozzle to create a reactable spray in the reaction chamber, thereby to form molten droplets which then freeze to form spheres or microspheres of germanium sulphide.

58. The method of claim 43 wherein the reaction chamber is maintained at a pressure close to atmospheric during the reaction.

59. The method of claim 43 wherein the gas mixture is formed by:
providing a first gas stream of a carrier gas containing the germanium tetrachloride (GeCl₄);
providing a second gas stream of the hydrogen sulphide (H₂S); and
mixing the first and second gas streams prior to introduction into the reaction chamber.

60. The method of claim 59 wherein the carrier gas is an inert gas.

61. The method of claim 43 wherein the hydrogen sulphide (H₂S) acts as a carrier gas for the germanium tetrachloride (GeCl₄).

62. The method of claim 1, further comprising:
providing in the gas mixture one or more of the following metal chlorides:

| | | | |
|---|---|---|---|
| TlCl | NbCl₅ | HfCl₄ | BiCl₃ |
| TeCl₄ | NdCl₃ | AuCl | BaCl₂ |
| TaCl₅ | MoCl₃ | GeCl₄ | NaCl |
| SiCl₄ | HgCl₂ | GdCl₃ | AlCl₃ |
| Se₂Cl₂ | MnCl₂ | ErCl₃ | PCl₃ |
| RuCl₃ | MgCl₂ | DyCl₃ | KCl |
| RbCl | LuCl₃ | CuCl₂ | CaCl₂ |
| RhCl | LiCl | CuCl | GaCl₃ |
| PrCl₃ | PbCl₂ | CoCl₂ | SnCl₃ |
| PtCl₂ | LaCl₃ | CrCl₂ | TmCl₃ |
| PdCl₅ | FeCl₃ | CsCl | YCl₃ |
| InCl₃ | IrCl₃ | CdCl₂ | AsCl₃ |
| WCl₆ | HoCl₃ | SbCl₃ | ZrCl₄ |
| TiCl₄ | ZnCl₂ | VCl₄ | AgCl |

in order to modify the germanium sulphide being synthesised.

63. A compound of germanium sulphide obtained by the method of claim 43.

64. A compound of germanium sulphide obtained by the method of claim 43 wherein transition metal impurities are present at levels of less than 1 ppm.

65. A compound of germanium sulphide obtained by the method of claim 43 wherein transition metal impurities are present at levels of less than 0.1 ppm.

66. A compound of germanium sulphide obtained by the method of claim 43 wherein carbon impurities are present at levels of less than 1 ppm.

67. A compound of germanium sulphide obtained by the method of claim 43 wherein oxygen impurities are present at levels of less than 1000 ppm.

68. A compound according to claim 63 further comprising as modifiers one or more of the following elements: P, Ga, As.

69. A compound according to claim 63 further comprising one or more of the lanthanide elements: Ce, Pr, Nd, Pm, Sm, Eu, Gd, Tb, Dy, Ho, Er, Tm, Yr, and Lu.

70. A compound according to claim 63 further comprising one or more of the transition metal elements: Ti, V, Cr, Mn, Fe, Co, Ni, Cu.

71. A compound according to claim 63 further comprising one or more oxides of the following elements to increase the photosensitivity of the compound: Sn, B, Na, Li, K, Ag, Au, Pt.

72. A compound according to claim 63 wherein the compound is in glass form.

73. A compound according to claim 63 wherein the compound is in crystalline powder form.
